(19) United States
(12) Patent Application Publication
(10) Pub. No.: US 2026/0203439 A1
(43) Pub. Date: Jul. 16, 2026

(54) ENHANCING DATA PRIVACY IN PARQUET DATA FILE SYSTEMS

(71) Applicant: MASTERCARD TECHNOLOGIES CANADA ULC, Vancouver (CA)

(72) Inventors: Murali Mani, Chappaqua, NY (US); John Hearty, Vancouver (CA)

(21) Appl. No.: 19/023,069

(22) Filed: Jan. 15, 2025

(51) Int. Cl. G06F 21/62; G06F 12/02; G06F 16/11; G06F 16/16

(52) U.S. Cl. CPC G06F 21/6245; G06F 12/0253; G06F 16/125; G06F 16/162

(57) ABSTRACT

Enhancing data privacy in parquet data file systems. One self-purging database server comprises a memory storing executable instructions, and an electronic processor communicatively coupled to the memory, the electronic processor configured to obtain a columnar storage file and a timestamp index file associated with the columnar storage file, wherein the columnar storage file includes one or more time-indexed data records, a time-indexed data record including a creation timestamp and a retention period, and perform an integrated garbage collection on the columnar storage file including automatically deleting one or more expired records in the columnar storage file based on the timestamp index file and retention periods of the one or more expired records.

### FIELD

Examples described herein generally relate to enhancing data privacy. In particular, examples described herein provide automated data deletion in database systems including parquet data file systems.

### BACKGROUND

Data retention and privacy management have become concerns in the era of big data and stringent regulatory environments. Organizations across various sectors are motivated to store vast amounts of data, including personal information of individuals. Recordkeeping Regulations mandate a minimum retention period. Simultaneously, the organizations need to adhere to data privacy regulations that mandate the deletion of data once the retention period expires. This balancing act between data retention and timely deletion for privacy protection creates a demand for the development of sophisticated data management systems.

One challenge in managing such vast amounts of data lies in the conflicting requirements of minimum retention periods for long-term storage and timely deletion. While data may be retained for extended periods, privacy regulations demand that personal data be deleted as soon as the retention period expires and there is no legitimate purpose for its continued storage. This creates a complex scenario where different records within the same dataset may have varying retention periods, making bulk deletion inefficient, and individual record deletion computationally difficult and expensive.

Some methods for addressing this challenge rely on manual interventions by data analysts or system administrators. These approaches may involve executing custom queries at fixed intervals, which can interrupt normal data processing operations. Moreover, such methods require additional steps to collect and store evidence of deletion actions for audit purposes, further complicating the process and placing additional regulatory documentation requirements on personnel. The computational cost of searching through large datasets to identify and delete individual expired records can be prohibitively high, especially when dealing with the scale of data common in modern database environments. This is further complicated in distributed environments with multiple copies of datasets.

Examples of the present disclosure address these limitations and improve the functioning of data file systems by integrating data retention management directly into the garbage collection process of columnar file systems, therefore enhance the data privacy of such systems. This novel approach involves automatic, continuous compliance with data deletion requirements at the individual record level, without the need for separate deletion operations or manual oversight. By leveraging the existing file structure and optimization techniques of columnar formats like Parquet, the present disclosure involves efficient identification and removal of expired records during routine maintenance processes. This integration of data retention management into garbage collection improves the functioning of a data management apparatus, platform, or system by enabling automatic compliance with regulatory data retention and deletion requirements, minimizing computational overhead, and reducing the risk of human error in managing data retention and deletion tasks. The automation of data deletion eliminates the need for maintaining additional evidence or logs of deletion activities and associated costs, complexity and record retention requirements. Furthermore, the approach can be introduced into existing file systems through an upgrade to the garbage collection process.

### SUMMARY

According to embodiments to the present disclosure, a self-purging database server comprises a memory storing executable instructions; and an electronic processor communicatively coupled to the memory, the electronic processor configured to obtain a columnar storage file and a timestamp index file associated with the columnar storage file, where the columnar storage file includes one or more time-indexed data records, a time-indexed data record including a creation timestamp and a retention period; and perform an integrated garbage collection on the columnar storage file including automatically deleting one or more expired records in the columnar storage file based on the timestamp index file and retention periods of the one or more expired records.

According to embodiments to the present disclosure, a non-transitory computer-readable medium storing instructions executable by a device to obtain a columnar storage file and a timestamp index file associated with the columnar storage file, wherein the columnar storage file includes one or more time-indexed data records, a time-indexed data record including a creation timestamp and a retention period; and perform an integrated garbage collection on the columnar storage file including automatically deleting one or more expired records in the columnar storage file based on the timestamp index file and retention periods of the one or more expired records.

According to embodiments to the present disclosure, a self-purging system comprises a timestamp indexer configured to create a timestamp index file associated with a columnar storage file, wherein the columnar storage file includes one or more time-indexed data records, a time-indexed data record including a creation timestamp and a retention period; and a self-purging apparatus configured to perform an integrated garbage collection on the columnar storage file including automatically deleting one or more expired records in the columnar storage file based on the timestamp index file and retention periods of the one or more expired records.

### BRIEF DESCRIPTION OF THE DRAWINGS

FIG. 1 illustrates an example of a data management system according to aspects of the present disclosure.

FIG. 2 illustrates an example of a self-purging data management apparatus according to aspects of the present disclosure.

FIG. 3 illustrates an example of an automatic data retention management process according to aspects of the present disclosure.

FIG. 4 illustrates an example of a computer-implemented data retention management method according to aspects of the present disclosure.

FIG. 5 illustrates an example of a computer-implemented data retention management method according to aspects of the present disclosure.

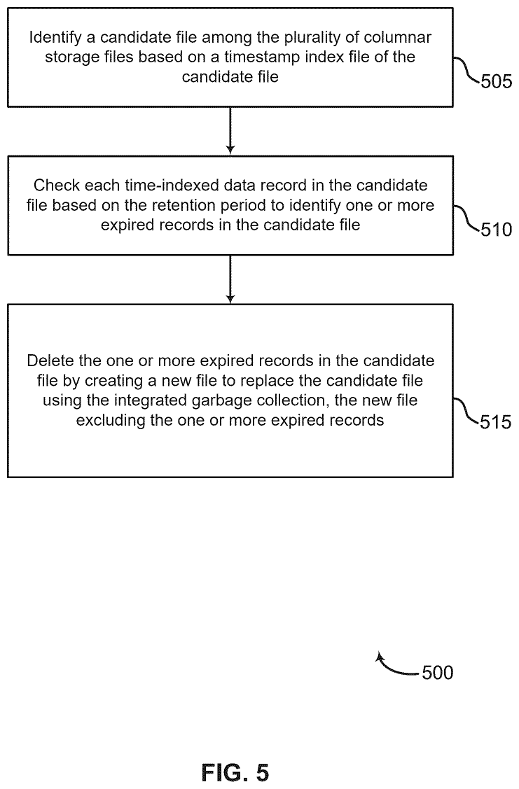

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

According to aspects of the present disclosure, the term “Parquet files” refer to a columnar storage file format designed for efficient data compression and encoding, suited for handling complex data in bulk. Parquet files may provide enhanced performance for large-scale data analytics operations. While the present disclosure may be applied to “Parquet files,” the present disclosure may also be applied other types of columnar storage file format designed for efficient data compression and encoding.

The term “time-indexed data records” refer to data entries organized and referenced by a timestamp, representing the creation time or occurrence of an event associated with a record.

The term “retention period” refers to a specified duration for which a data record is kept before the data record becomes eligible for deletion. The retention period may be determined by regulatory requirements or policies.

The term “garbage collection” refers to a periodic process of consolidating data files, such as removing unnecessary information, and optimizing storage usage in a database system. The garbage collection may be part of system maintenance and thus can be initiated and performed without external requests or intervention.

The term “Delta files” refers to intermediate files that store incremental changes or updates to the main dataset between full data rewrites or garbage collection processes.

The term “timestamp index” refers to a data structure that maintains information about the range of timestamps present in each data file, allowing for quick identification of files that may contain records from a specific time period.

The term “OPTIMIZE” refers to a technique used to reorganize data within files for improved compression and faster access. The term “ZORDER” refers to a multi-dimensional indexing method that involves efficient filtering and retrieval of data based on multiple columns, including timestamps.

The term “columnar file format” refers to a data storage format that organizes information by columns rather than rows, allowing for more efficient compression and faster query performance on large datasets.

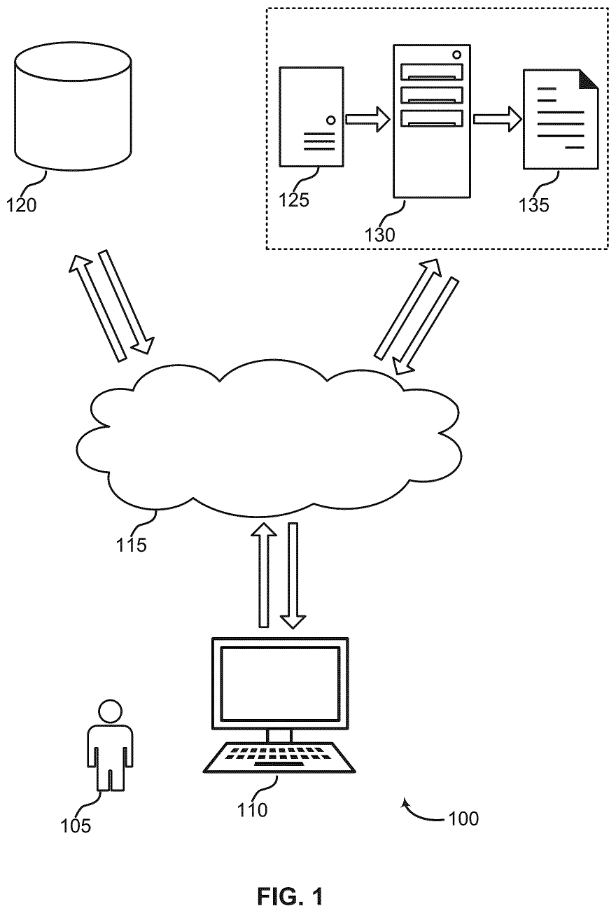

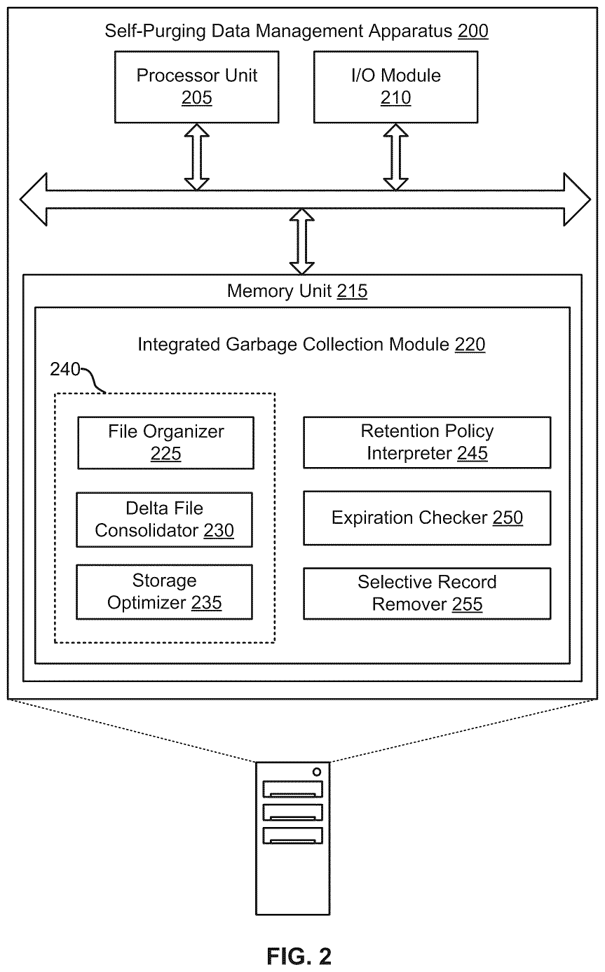

FIG. 1 illustrates an example data management system 100 according to aspects of the present disclosure. Data management system 100 includes user 105, user device 110, cloud 115, storage 120, timestamp indexer 125, self-purging apparatus 130, and audit log repository 135. Self-purging apparatus 130 is an example of, or includes aspects of, the corresponding element described with reference to FIG. 2.

In FIG. 1, the storage 120, the timestamp indexer 125, the self-purging apparatus 130, and the audit log repository 135 are illustrated as separate components in the data management system 100. However, examples of the present disclosure may not be limited thereto. In some examples, the storage 120, the timestamp indexer 125, the self-purging apparatus 130, and the audit log repository 135 may be included in a server. For example, the server may create a timestamp index file using a timestamp index module, and then delete expired records based on the timestamp index file.

In the examples illustrated in FIG. 1, the user 105 in data management system 100 include entities that interact with or provide input to the data management system 100. In some examples, the user 105 may represent human actors such as compliance officers, data administrators, or regulatory authorities. In some alternative examples, the user 105 may include non-human entities. For example, the user 105 may be automated systems implementing data privacy regulations, machine learning algorithms designed to adapt retention policies based on evolving legal requirements, or inter-organizational data exchange protocols that dictate specific retention periods for shared information. In some examples, the user 105 may be an API (Application Programming Interface) from a regulatory body that automatically updates retention policies across multiple organizations, or a smart contract system on a blockchain network that governs data retention for decentralized applications. Accordingly, the user 105 provided herein refers an entity capable of defining, updating, or enforcing data retention policies within the context of the data management system 100.

In this example, the user 105 sends a request via the user device 110 to provide data retention policy regarding the data records stored. In some examples, the data retention policy may be different for different data records stored in the same file. In some examples, upon receiving the request, the data management system 100 retrieves the information indicating the retention period for the data records. The data management system 100 may re-organize the data records in columnar store files such as Parquet format files in order to increase efficiency in storage and retrieval, and to implement the automatic data retention management according to aspects of the present disclosure.

In this example, the data management system 100 may automatically incorporate the retention policy into ongoing operations without requiring specific initiations from the user 105. For example, as new customer transaction records are stored in the storage 120, the new customer transaction records are automatically tagged with the appropriate retention period. The timestamp indexer 125 continuously maintains an index of timestamp ranges for the stored files, facilitating efficient identification of records subject to the retention policy during future garbage collection cycles.

In this example, the self-purging apparatus 130 uses the index of timestamp ranges from the timestamp indexer 125 to identify files potentially containing records that have exceeded the retention period. For example, during each garbage collection cycle, the self-purging apparatus 130 may identify a group of candidate files based on timestamp files generated by the timestamp indexer 125. The self-purging apparatus 130 then examines the identified files, checking individual records against the retention policy. The self-purging apparatus 130 then creates new files that exclude expired records, thus removing expired records from the dataset without manual intervention or specific request-based processing.

During the automated and continuous process, the audit log repository 135 records detailed information about each processed and deleted record, maintaining a comprehensive audit trail for compliance verification. The audit log repository 135 may ensure that the data management system 100 maintains ongoing compliance with the retention policy for customer transaction records as a standard part of operation.

In the data management system 100 illustrated in FIG. 1, the user device 110 may be a personal computer, laptop computer, mainframe computer, palmtop computer, personal assistant, mobile device, or any other suitable processing apparatus. A user interface may be used for the user 105 to interact with the user device 110. In some aspects, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 110 and rendered locally by a browser.

In some examples, the timestamp indexer 125, the self-purging apparatus 130, and the audit log repository 135 may be implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various aspects, a server comprises a general-purpose computing device, a personal computer, a laptop computer, a mainframe computer, a supercomputer, or any other suitable processing apparatus.

The cloud 115 is a computer network configured to provide on-demand availability of computer system resources, such as data storage and computing power. In some examples, the cloud 115 provides resources without active management by the user. The term cloud is sometimes used to describe data centers available to many users over the Internet. Some large cloud networks have functions distributed over multiple locations from central servers. In some examples, the server is designated an edge server when the server has a direct or close connection to a user. In some cases, the cloud 115 is limited to a single organization. In other examples, the cloud 115 is available to many organizations. In one example, the cloud 115 includes a multi-layer communications network comprising multiple edge routers and core routers. In another example, the cloud 115 is based on a local collection of network switches in a single physical location. It should be understood that, in some examples, the cloud 115 is not included in the data management system 100. In these examples, the timestamp indexer 125 and the self-purging apparatus 130 may communicate with the user device 110 directly (over one or more wired or wireless connections) or may be implemented locally on the user device 110. The user device 100 may include components or interfaces, such as communication modules or software frameworks, that manage data exchanged between the timestamp indexer 125 and the self-purging apparatus 130.

The storage 120 is an organized collection of data. For example, the storage 120 stores data in a specified format known as a schema. The storage 120 may be structured as a single database, a distributed database, multiple distributed databases, or an emergency backup database. In some cases, a database controller may manage data storage and processing in the storage 120. In some cases, a user interacts with the database controller. In other cases, database controllers may operate automatically without user interaction. It should be understood that, in some examples, the storage 120 includes non-transitory computer-readable storage medium for storing data used and/or generated by the self-purging apparatus 130 and, thus, may represent remote storage (without or without standard database functionality).

In some examples, the storage 120 may store the time-indexed data records in a columnar file format, specifically the Parquet format. In some examples, each record within the storage 120 includes a creation timestamp and a retention period. The storage 120 may be implemented as a distributed storage system to handle large volumes of data efficiently. In some examples, the timestamp indexer 125 continuously updates this index as new data is added or existing data is modified. The timestamp index generated by the timestamp indexer 125 may be used for quick identification of files that may contain records from specific time ranges.

In some examples, the self-purging apparatus 130 coordinates the interactions between various system components and executes the primary data management functions. The integrated garbage collection module within the self-purging apparatus 130 is configured to automatically identify candidate files based on their timestamp indices during garbage collection, check each record in the candidate files based on their retention periods to identify expired records, and create new files by excluding the identified expired records from the candidate files. In some examples, the self-purging apparatus 130 also includes a file organizer component configured to organize the records within files based on their timestamps using a ZORDER technique.

In some examples, a pre-determined deletion timestamp is added to a data record indicating a deletion. The integrated garbage collection module is further configured to exclude records with the pre-determined deletion timestamp from new files created during an integrated garbage collection process. For example, the pre-determined deletion timestamp is added to a sensitive data record based on a regulatory requirement. The integrated garbage collection module creates the new file excluding the sensitive data record during the integrated garbage collection based on the pre-determined deletion timestamp.

The data management system 100 may include an audit log repository 135 configured to store records of deletion of the one or more expired records. The audit log repository 135 may be configured to maintain a comprehensive record of data deletion activities within the data management system 100. In some examples, the audit log repository 135 captures information about each record that is removed during the integrated garbage collection process, including the record's identifier, timestamp, retention period, and the date of deletion. The information may be stored as evidence for audit purposes. The audit log has an expiry date and may also be managed through a retention policy and the self-purging data management apparatus 200.

FIG. 2 illustrates an example of a self-purging data management apparatus 200 according to aspects of the present disclosure. The self-purging data management apparatus 200 may be an example of a server including the self-purging apparatus 130 in FIG. 1. In some examples, the self-purging data management apparatus 200 may also include the timestamp indexer 125 and the audit log repository 135 of FIG. 1.

The self-purging data management apparatus 200 includes a processor unit 205, communication interface 210, a memory unit 215, and an integrated garbage collection module 220. The integrated garbage collection module 220 includes the file organizer 225, the delta file consolidator 230, the storage organizer 235, the retention policy interpreter 245, the expiration checker 250, and the selective record remover 255.

The processor unit 205 includes one or more electronic processors. An electronic processor is a hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some examples, the processor unit 205 is configured to operate a memory array using a memory controller. In other examples, a memory controller is integrated into the processor unit 205. In some examples, the processor unit 205 is configured to execute computer-readable instructions stored in the memory unit 215 to perform various functions. In some aspects, the processor unit 205 includes special purpose components for modem processing, baseband processing, digital signal processing, or transmission processing.

The memory unit 215 includes one or more memory devices. Examples of a memory device include random access memory (RAM), read-only memory (ROM), a hard disk, a solid-state driver, or other suitable electronic storage medium. In some examples, memory is used to store non-transitory computer-readable, computer-executable software including instructions that, when executed, cause at least one processor of the processor unit 205 to perform various functions described herein.

In some examples, the memory unit 215 includes a basic input/output system (BIOS) that controls basic hardware or software operations, such as an interaction with peripheral components or devices. In some examples, the memory unit 215 includes a memory controller that operates memory cells of the memory unit 215. For example, the memory controller may include a row decoder, column decoder, or both. In some cases, memory cells within the memory unit 215 store information in the form of a logical state.

The communication interface 210 manages the flow of information between the computer system and external devices or users. For example, the communication interface 210 handles input from devices such as keyboards, mice, or microphones, and manages output to displays, speakers, or other peripherals. In some examples, the communication interface 210 includes a user interface component.

In the self-purging data management apparatus 200, the integrated garbage collection module 220 combines garbage collection functionalities with data retention management capabilities. The integrated garbage collection module 220 includes the file organizer 225, the delta file consolidator 230, the storage organizer 235, the retention policy interpreter 245, the expiration checker 250, and the selective record remover 255.

The file organizer 225 may be configured to scan and organize the stored files in the system. In some examples, the file organizer 225 analyzes the structure and content of files, identifying areas that may require further processing or consolidation. In these examples, the file organizer 225 may also utilize the timestamp index to identify files that are candidates for processing based on their timestamp ranges.

By identifying candidate files for subsequent processing, the file organizer 225 leverages the computation in garbage collection for file retention management. In some examples, the number of candidate files is less than the number of stored files in the system.

The delta file consolidator 230 may be configured to manage the integration of changes stored in delta files into the main data files. In some examples, the delta file consolidator 230 processes the interim changes that have been recorded between garbage collection cycles and incorporates these changes into the consolidated files. Using the delta file consolidator 230, recent modifications to the data are properly integrated during the garbage collection process.

The storage organizer 235 may be configured to increase the efficiency of data storage. In some examples, the storage organizer 235 may reorganize data within files to increase compression ratios, organize file sizes, and improve read/write performance. In some examples, the storage organizer 235 may employ techniques such as ZORDER to arrange records within files for better overall system performance.

The retention policy interpreter 245 may be configured to process and interpret the retention policies associated with each record. For example, the retention policy interpreter 245 calculates expiration dates for records based on their creation timestamps and specified retention periods. The retention policy interpreter 245 provides information for determining which records have exceeded their retention periods and are eligible for deletion.

The expiration checker 250 may be configured to evaluate records against calculated expiration dates. For example, the expiration checker 250 compares the current date with the expiration date of each record to identify which records have expired. The expiration checker 250 works together with the retention policy interpreter 245 to make accurate decisions about record expiration.

The selective record remover 255 may be configured to create new files that exclude expired records. For example, the selective record remover 255 processes the original files, omitting records that have been identified as expired by the expiration checker 250. The selective record remover 255 thus effectively implements the deletion of expired records by excluding the expired records from the newly created files, rather than modifying existing files directly.

According to aspects of the present disclosure, the retention policy interpreter 245, expiration checker 250, and the selective record remover 255 work in conjunction to provide an integrated solution for data management and retention enforcement. By combining these functionalities, the integrated garbage collection module 220 may automate compliant data retention practices within the larger data management system.

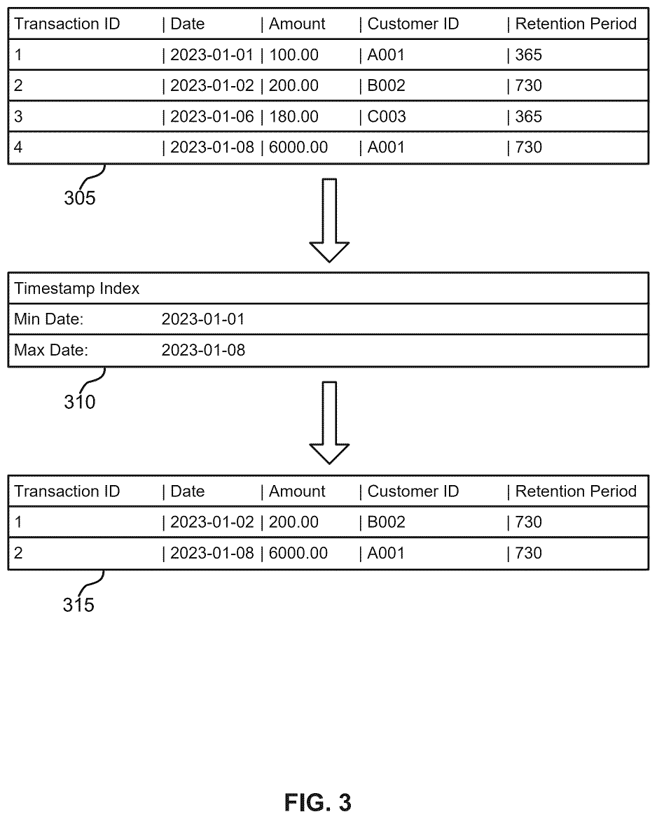

FIG. 3 illustrates an example of automatic data retention management process 300 according to aspects of the present disclosure. The automatic data retention management process 300 includes an Initial Data Set 305, a Timestamp Index 310, and a Resulting Data Set 315.

In this example, the Initial Data Set 305 represents the original set of time-indexed data records stored in the columnar file format. In the example of FIG. 3, for ease of understanding, the table of Initial Data Set 305 contains records with Transaction ID, Date, Amount, Customer ID, and Retention Period fields. However, the table of Initial Data Set 305 may include more records or less records than what is illustrated in FIG. 3. The Initial Data Set shows four transactions with varying dates, amounts, customer IDs, and retention periods. These records demonstrate the diversity of data the system manages, each record with a corresponding creation date and retention requirement.

In this example, the Timestamp Index 310 may be generated by the timestamp indexer in FIG. 1 based on the Initial Data Set 305. The Timestamp Index 310 provides a reference for the range of dates contained within the file. In this example, the Timestamp Index 310 indicates a Min Date of 2023 Jan. 1 and a Max Date of 2023 Jan. 8. This index may be used by the self-purging data management apparatus 200 to determine when a file potentially contains records that need processing during garbage collection, without the need to scan every individual record in the file. The self-purging data management apparatus 200 may consider any file that includes a date on or between the min and max dates to be a candidate file. In another example, the Timestamp Index 310 may be provided by a user, retrieved from a database, sourced from external systems, or received from other suitable sources.

In this example, the Resulting Data Set 315 displays the outcome after the application of the integrated garbage collection process. The table of Resulting Data Set 315 contains fewer records than the Initial Data Set, indicating the removal of some records based on the corresponding retention periods. In this example, the current date is as of September 2024. The Resulting Data Set 315 retains only transactions with a retention period of 730 days, and those with shorter retention periods of 365 days have been removed. Accordingly, the transformation from the Initial Data Set to the Resulting Data Set demonstrates the system's capability to identify records that have exceeded corresponding retention periods, selectively remove expired records while retaining those still within the retention periods, and maintain data integrity by preserving information for retained records as well as for auditing purposes.

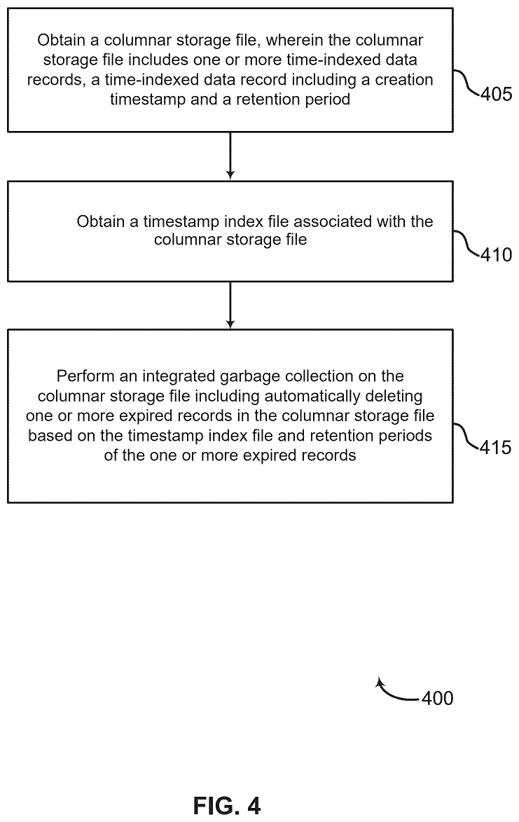

FIG. 4 illustrates an example data retention management method 400 using the data management system 100 including the self-purging data management apparatus 200. Operations in data retention management method 400 may be implemented by corresponding elements described with reference to FIGS. 1 and 2.

The data retention management method 400 includes the self-purging data management apparatus 200 obtaining a columnar storage file, wherein the columnar storage file includes one or more time-indexed data records, a time-indexed data record including a creation timestamp and a retention period (at operation 405). In some examples, obtaining a columnar storage file further includes the self-purging data management apparatus 200 organizing and storing data in a columnar file format that is organized for time-based queries and retention management.

For example, each record stored in a columnar file format includes a creation timestamp, which indicates when the record was created, and a retention period, which specifies how long the record should be kept before it can be considered for deletion. Using a Parquet format may enhance performance when handling complex data in bulk, which is beneficial for large-scale data analytics and retention management systems.

The data retention management method 400 includes the self-purging data management apparatus 200 obtaining a timestamp index file associated with the columnar storage file (at operation 410). For example, the self-purging data management apparatus 200 may receive timestamp index file from the timestamp indexer 125. In this example, the timestamp indexer 125 generates and continuously updates an index that keeps track of the range of timestamps present in each stored file. This index may be used as a reference for identifying which files contain records that may be expired from a particular time range, without needing to scan the entire contents of each file. In some examples, the self-purging data management apparatus 200 may receive the timestamp index file from a user, a database, or from external systems.

In some examples, the creation and maintenance of this timestamp index may involve using optimization techniques. For example, the records within the files may be organized based on timestamps using OPTIMIZE and ZORDER techniques. OPTIMIZE may involve reorganizing data within files for better compression and faster access. ZORDER may create a multi-dimensional index that allows for quick filtering on multiple columns, including timestamps.

The data retention management method 400 includes the integrated garbage collection module 220 performing an integrated garbage collection on the columnar storage file including automatically deleting one or more expired records in the columnar storage file based on the timestamp index file and retention periods of the one or more expired records (at operation 415).

In some examples, at operation 415, the retention policy interpreter 245 in the integrated garbage collection module 220 uses the previously created timestamp index to efficiently identify candidate files that are likely to contain expired records. For each identified candidate file, the expiration checker 250 in the integrated garbage collection module 220 then examines individual records, comparing each individual record's creation timestamp and retention period against the current time to determine when each individual record has expired. The selective record remover 255 in the integrated garbage collection module 220 then creates a new version of the file that excludes expired records, thus deleting expired records from the database.

In some examples, the integrated garbage collection is automatically initiated and performed as part of periodical database system maintenance. For example, the integrated garbage collection process described in this operation may be performed on a regular schedule. using the VACUUM technique. The VACUUM technique is a database maintenance tool that removes unused files and reclaims storage space in a database. This periodic execution ensures that data retention policies are consistently enforced without requiring manual intervention.

In some examples, each file's timestamp index includes a minimum timestamp and a maximum timestamp of the file. The process of identifying candidate files involves comparing the maximum timestamp of each file's timestamp index with a calculated expiration threshold. With this approach, the integrated garbage collection module 220 excludes files that do not contain expired records with low computational cost by leveraging the garbage collection, facilitating the system to focus the more detailed record-level checks on candidate files that are more likely to contain expired data. In some examples, a timestamp index file associated with the candidate file includes a maximum timestamp and a minimum timestamp. To identify the candidate file, the self-purging apparatus is further configured to determine that the candidate file includes any time-indexed data records that include the creation timestamp that is on or between the maximum timestamp and the minimum timestamp.

In some examples, the data management system 100 may store, in delta files, changes to the time-indexed data records before performing the integrated garbage collection, and consolidates the delta files during the integrated garbage collection. A new file is created based on the consolidated delta files. In these examples, the system may handle interim changes to the data between garbage collection processes. This approach involves efficiently updating the dataset without the need to rewrite entire files, with the consolidation of these changes occurring during the regular garbage collection process, effectively delivering both garbage collection and automatic data retention management at the same time.

In some examples, when a size of the consolidated delta files exceeds a threshold, the integrated garbage collection may be triggered. However, examples of the present disclosure are not limited thereto. The integrated garbage collection may be triggered when a trigger event occurs. The trigger event may include one of a size of a delta file exceeding a threshold, a data retention policy being updated, a manual request being received, a scheduled maintenance taking place, or other suitable trigger event. The processor unit 205 may perform the integrated garbage collection responsive to detecting the trigger event occurs.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

What is claimed is:

1. A self-purging database server comprising:
a memory storing executable instructions; and
an electronic processor communicatively coupled to the memory, the electronic processor configured by the executable instructions to:
obtain a columnar storage file and a timestamp index file associated with the columnar storage file, wherein the columnar storage file includes one or more time-indexed data records, a time-indexed data record including a creation timestamp and a retention period relative to the creation timestamp; and
perform an integrated garbage collection on the columnar storage file including automatically deleting one or more expired records in the columnar storage file based on the timestamp index file and retention periods of the one or more expired records.

2. The self-purging database server of claim 1, wherein, to perform the integrated garbage collection, the electronic processor is further configured to:
identify a candidate file among a plurality of columnar storage files based on a timestamp index file associated with the candidate file;
check each of one or more time-indexed data records in the candidate file based on the retention period to identify one or more expired records in the candidate file; and
delete the one or more expired records in the candidate file by creating a new file, the new file excluding the one or more expired records from the candidate file.

3. The self-purging database server of claim 2, wherein the timestamp index file associated with the candidate file includes a maximum timestamp and a minimum timestamp, and wherein to identify the candidate file, the electronic processor is further configured to:
determine that the candidate file includes any time-indexed data records that include the creation timestamp that is on or between the maximum timestamp and the minimum timestamp.

4. The self-purging database server of claim 1, wherein, to perform the integrated garbage collection, the electronic processor is further configured to:
consolidate delta files, the delta files storing changes to the one or more time-indexed data records before the integrated garbage collection, wherein a new file excluding the one or more expired records is created based on the consolidated delta files.

5. The self-purging database server of claim 1, wherein, to perform the integrated garbage collection, the electronic processor is further configured to:
detect whether a trigger event occurs, wherein the trigger event includes one of a size of a delta file exceeding a threshold, a data retention policy being updated, a manual request being received, or a scheduled maintenance taking place, and
responsive to detecting the trigger event occurs, perform the integrated garbage collection.

6. The self-purging database server of claim 1, wherein, to perform the integrated garbage collection, the electronic processor is further configured to:
create a new file excluding a sensitive data record based on a pre-determined deletion timestamp, wherein the pre-determined deletion timestamp is added to the sensitive data record based on a data privacy requirement.

7. The self-purging database server of claim 1, wherein the columnar storage file is a file in Parquet format.

8. A non-transitory computer-readable medium storing instructions executable by a device to:
obtain a columnar storage file and a timestamp index file associated with the columnar storage file, wherein the columnar storage file includes one or more time-indexed data records, a time-indexed data record including a creation timestamp and a retention period relative to the creation timestamp; and
perform an integrated garbage collection on the columnar storage file including automatically deleting one or more expired records in the columnar storage file based on the timestamp index file and retention periods of the one or more expired records.

9. The non-transitory computer-readable medium of claim 8, wherein to perform the integrated garbage collection, the non-transitory computer-readable medium stores instructions executable by the device to further:
identify a candidate file among a plurality of columnar storage files based on a timestamp index file associated with the candidate file;
check each of one or more time-indexed data records in the candidate file based on the retention period to identify one or more expired records in the candidate file; and
delete the one or more expired records in the candidate file by creating a new file, the new file excluding the one or more expired records from the candidate file.

10. The non-transitory computer-readable medium of claim 9, wherein the timestamp index file associated with the candidate file includes a maximum timestamp and a minimum timestamp, and wherein to identify the candidate file, the non-transitory computer-readable medium stores instructions executable by the device to further:
determine that the candidate file includes any time-indexed data records that include the creation timestamp that is on or between the maximum timestamp and the minimum timestamp.

11. The non-transitory computer-readable medium of claim 8, wherein to perform the integrated garbage collection, the non-transitory computer-readable medium stores instructions executable by the device to further:
consolidate delta files, the delta files storing changes to the one or more time-indexed data records before the integrated garbage collection, wherein a new file excluding the one or more expired records is created based on the consolidated delta files.

12. The non-transitory computer-readable medium of claim 8, wherein to perform the integrated garbage collection, the non-transitory computer-readable medium of claim stores instructions executable by the device to further:
detect whether a trigger event occurs, wherein the trigger event includes one of a size of a delta file exceeding a threshold, a data retention policy being updated, a manual request being received, or a scheduled maintenance taking place, and
responsive to detecting the trigger event occurs, perform the integrated garbage collection.

13. The non-transitory computer-readable medium of claim 8, wherein to perform the integrated garbage collection, the non-transitory computer-readable medium of claim stores instructions executable by the device to further:
create a new file excluding a sensitive data record based on a pre-determined deletion timestamp, wherein the pre-determined deletion timestamp is added to the sensitive data record based on a data privacy requirement.

14. The non-transitory computer-readable medium of claim 8, wherein the columnar storage file is a file in Parquet format.

15. A self-purging system comprising:
a timestamp indexer configured to create a timestamp index file associated with a columnar storage file, wherein the columnar storage file includes one or more time-indexed data records, a time-indexed data record including a creation timestamp and a retention period relative to the creation timestamp; and
a self-purging apparatus configured to:
perform an integrated garbage collection on the columnar storage file including automatically deleting one or more expired records in the columnar storage file based on the timestamp index file and retention periods of the one or more expired records.

16. The self-purging system of claim 15, wherein to perform the integrated garbage collection, the self-purging apparatus is further configured to:
identify a candidate file among a plurality of columnar storage files based on a timestamp index file associated with the candidate file;
check each of one or more time-indexed data records in the candidate file based on the retention period to identify one or more expired records in the candidate file; and
delete the one or more expired records in the candidate file by creating a new file, the new file excluding the one or more expired records from the candidate file.

17. The self-purging system of claim 16, wherein the timestamp index file associated with the candidate file includes a maximum timestamp and a minimum timestamp, and wherein to identify the candidate file, the self-purging apparatus is further configured to:
determine that the candidate file includes any time-indexed data records that include the creation timestamp that is on or between the maximum timestamp and the minimum timestamp.

18. The self-purging system of claim 16, wherein to perform the integrated garbage collection, the self-purging apparatus is further configured to:
detect whether a trigger event occurs, wherein the trigger event includes one of a size of a delta file exceeding a threshold, a data retention policy being updated, a manual request being received, or a scheduled maintenance taking place, and
responsive to detecting the trigger event occurs, perform the integrated garbage collection.

19. The self-purging system of claim 15, further comprising:
a file organizer configured to arrange the one or more time-indexed data records in the columnar storage file based on timestamps using techniques including at least one of OPTIMIZE and ZORDER.

20. The self-purging system of claim 15, further comprising:
an audit log repository configured to store records of deletion of the one or more expired records.
